(19) United States
(12) Patent Application Publication
(10) Pub. No.: US 2024/0286504 A1
(43) Pub. Date: Aug. 29, 2024

(54) Secured "low voltage" sliding conductive connection device for static and dynamic charging of electric vehicles and associated methods

(71) Applicant: Philippe Constant Nobileau, VILLEFRANCHE/MER (FR)

(72) Inventor: Philippe Constant Nobileau, VILLEFRANCHE/MER (FR)

(21) Appl. No.: 18/637,323

(22) Filed: Apr. 16, 2024

Related U.S. Application Data
(63) Continuation-in-part of application No. PCT/IB2022/059996, filed on Oct. 18, 2022.

(30) Foreign Application Priority Data
Oct. 18, 2021 (FR) FR2111004

(51) Int. Cl. B60L 53/16

(52) U.S. Cl. CPC B60L 53/16

(57) ABSTRACT

Conductive, dynamic and static connection device for electrical supply of electrically propelled vehicles comprising one current collector on board the vehicles, and one fixed conduit, comprising a vertical slot, opening into a cavity of the conduit to receive, vertically or horizontally, the current collector, the cavity containing electrical contact surfaces connected to a source, the contact surfaces being recessed from direct access through the slot, the electrical conductive supply comprises at least three conductors, one of which is “ground”, the vertical slot of the fixed conduit having a width “L” of less than 12 mm preventing the introduction of fingers in the slot, and in case the current collector is entering the conduit vertically, the collector comprises two current shoe assemblies articulated on a longitudinal horizontal axis, the rotation around the longitudinal horizontal axis between the vertical retrieval position and the contact position being less than 60 degrees.

The is a National Entry of international application PCT/IB2022/059996 filed Oct. 18^{th}, 2022 designating the US and published under WO 2023/067496 A1 on Apr. 27^{th}, 2023 having a foreign priority application FR2111004 filed Oct. 18th, 2021 and published on BOPI 23/17 under 3.128.415 claiming additional priority from U.S. Ser. No. 18/637,323 filed Apr. 16, 2024. The entire disclosures of the prior applications are incorporated herein by this reference.

### TECHNICAL FIELD

The present invention concerns an electrical sliding pavement conductive connection device for static and dynamic charging of electric vehicles.

The electrification of the automobile fleet, light vehicles, commercial vehicles, coaches, heavy-duty trucks, is faced with the problem of charging the batteries of these vehicles via an electric connection, which requires: a) the immobilization of the vehicle and b) the installation of a cable manually connecting the electrical source to the onboard battery's charger.

### BACKGROUND ART

In the international application PCT/IB2021/051187, which was the subject of a publication WO 2021/161247, the applicant proposed a highly automated mode of circulation for electric vehicles with a dynamic conductive power supply in SELV (Safety Extra Low Voltage) limited to 120 volts in direct current, but this configuration generates amperages that are too high to supply heavy-duty vehicles with rapid charging, particularly for urban buses at stops.

The present invention provides a new solution for connecting with low voltage vehicles (Low Voltage <1,000 volts AC and 1,500 volts DC) from a fixed electrical source, with a pavement conduit acting as an elongated socket, allowing dynamic and static charging, having on one hand on its upper face an elongated slit with a width less than the safety standard preventing the penetration of a finger in the slit, this slit is currently set at 12 mm in Europe (IEC 60529), and having on another hand a special geometry that allows the elongated contact surfaces under electric voltage to be placed in an inclined overhang in a cavity further preventing accidental access to the “hot” surfaces. This continuous elongated socket is suitable for installation on the traffic lanes of highways and expressways where the presence of people is restricted but not forbidden and also in limited length in parking lots and charging station. In addition the present invention allows the vehicle onboard collector to enter the ground elongated socket:
vertically for dynamic charging from continuous socket and
horizontally and vertically in limited length sockets for static charging.

Previous art of Low Voltage power supply configurations with ground conduit present the following limitations in term of electric protection and power capability for open road with high level of traffic including trucks:
US 7
,960,717 and US 2006/0286830 disclose conduits with flexible covering flaps to close the top slit with different level of protection which are not a viable solution in term of wear for high level of traffic on open road;
U.S. Pat. No. 2,068,403 discloses an elastically flexible track for electric car toys using SELV (Safety Extra Low Voltage) which offer no electric protection solution able to deal with a Low Voltage supply;
U.S. Pat. No. 10,981,459 disclose a charging trench with a power transfer blade which offer no electric protection whatsoever, restricting its use on open road to power supply in SELV (Safety Extra Low Voltage);
US 2008/0105509 and CN102,152,746 disclose an onboard collector which comprises a separate sub collector trapped in the conduit which is incompatible with private traffic fleet on an open road;
CN102,152,746, US 2013/0025989, U.S. Pat. No. 8,794,410, US 2015/0041273 and DE10 2014 223940 disclose power supply control systems which apply voltage to electrically conductive strips contained in the conduit when an electric vehicle is detected, and switches off the voltage when no electric vehicle is present, which result in strips of limited length (1 to 12 meters), separate power supply cables and large number (83 to 1,000 per km) embedded high power switching within the pavement.

Therefore, there is a need to dimension a pavement feed conduit which fulfill the electric protection requirements for installation on open road without requiring a complex and expensive power switching system from the fixed electrical source.
U.S. Pat. No. 4,129,203 discloses a more realistic connection system for a ground feed but fails to teach how to obtain large current shoe contact surfaces which are needed when large power transmission is required and traffic is following each other in a matter of seconds and not in a matter of minutes as for railroad traffic.

### BRIEF SUMMARY OF THE INVENTION

In consequence it is the primary object of the invention to overcome the lack of electric protected Low Voltage ground conduit design, while offering large contact surfaces suitable for high power transfer to numerous vehicles in dense traffic.

In addition it is an object of the invention to provide a grounded connection in both static and dynamic charging offering at least 3 cables of which one connected to the “ground”.

It is also an object of the invention, to provide an horizontal entry into the socket conduit for static charging and when the collector is entering the conduit vertically to limit the rotation of the current shoe assemblies articulated on longitudinal horizontal axis, to less than 60 degrees to permit on board direct electric connection to the shoes by large power cables.

It is a further object of the invention to apply a specific pressure on the onboard current shoes despite wear of the conduit's contacts and dimensional tolerance,

Accordingly, the present invention discloses a connection device for electrical conductive, dynamic and static charging of electrically propelled vehicles comprising one or more traction batteries, one current collector on board the vehicles, and one fixed conduit for power supply from the pavement, the conduit being substantially parallel to the direction of the displacement of the vehicles, comprising a vertical slit opening into a cavity of the conduit to receive, the current collector, the cavity containing at least two electrical contact surfaces connected to a fixed current source, the contact surfaces being recessed from direct access through the slit and positioned in inclined overhang, where:
the cavity (8, 8′) of the conduit has dual entry capability and allows to be entered, for establishing conductive electrical connection, either:
   vertically by the current collector (140, 140′, 200) through the vertical slit (12) or,
   horizontally by another current collector (70, 100) through at least one entrance (95) located at one end of the conduit for static charging,
the connection is established on at least three cables, one of which is connected to the “ground”,
the vertical slit of the fixed conduit having a width “L” of less than 12 mm, and
the vertical entry collector comprises two current shoe carriers articulated on longitudinal horizontal axis, the rotation of the current shoe holder around the longitudinal horizontal axis, between the vertical entry/retrieval position and the lateral connected position, being less than 60 degrees.
   a device for electrical conductive, dynamic and static, supply of electrically propelled vehicles comprising one or more traction batteries, one current collector on board the vehicles, and one fixed conduit, for power supply from the pavement, substantially parallel to the direction of displacement of the vehicles, comprising a vertical slit, opening into a cavity of the conduit to receive, vertically or horizontally by an entrance located at one end of the conduit, where the electrical conductive supply comprises at least three conductors, one of which is connected to “ground” the vertical slit of the fixed conduit, having a width “L” of less than 12 mm, preventing the introduction of fingers in the slit and in case the current collector is entering the conduit vertically, where the collector comprises two current shoe assemblies articulated on longitudinal horizontal axis, the rotation around the longitudinal horizontal axis, between the vertical retrieval position and the contact position, being less than 60 degrees.

In addition the present invention offers that the contact pressure between the onboard current shoes and the conduit's inclined over hanged contact surfaces is controlled by mechanical or air springs resting on the conduit.

At last, the metal structure of the continuous conduit can be plastically flexed, in the plane of the slit as it exits the manufacturing line to wind onto a transport spool and be plastically straightened as it is laid on the pavement.

The conduit, of a length exceeding the limits of road transportation, comprises a polymer body allowing the conduit to be wound on a spool of dimensions smaller than the road gauge, which gives it a behavior similar to that of a cable.

The conduit according to the invention is preferably installed in a groove grinded into the pavement, the upper surface of the conduit being flush with the pavement.

In another embodiment of the invention, the conduit is fixed to the pavement and the elastomeric body on either side of the conduit has a transverse surface, catching the level of the pavement, with a gentle slope.

The power contact surface has, on their faces facing the cavity, a low coefficient of friction and good resistance to abrasion and the electrical connection is made on the other opposite side by direct lateral contact with the power cable.

Drilling of successive water drainage holes through the concrete slab in the groove is carried out in the case of a pavement covered with non-draining asphalt.

The polymer body of the conduit is reinforced by at least one continuous open metal structure, preferably made from metal sheet having partial transverse cuts thus reducing the bending inertia in the plane of the slit. Preferably the power cables are single stranded and the metal profile is formed so that the conduit can be:
plastically flexed as it exits from the production line to wind onto the transport reel and
straightened during installation in the groove by a roller bending assembly.

Due to the substantial cross-sections of the power cables, longitudinal bending and unbending of the underside, transversely cut, of the metal profile about a longitudinal axis allows the power cables to be inserted.

The slit edges are metallic and electrically connected to “ground” and have a height equal to or greater than the width of the slit, with the collector carried by the vehicle being in contact with at least one of the metallic edges.

Preferably the power cables are aluminum with copper or steel contact surfaces, possibly stainless, and the contact surfaces have partial transverse cuts reducing the bending inertia in the plane of the slit.

The conduit is supplied with direct current and comprises two electrical contact surfaces positioned in inclined overhang on either side of the slit in a cavity, advantageously one is supplied with a low voltage of a potential difference lower than “ground” and the other with a low voltage of a potential difference higher than “ground”. Preferably, the DC voltages can be +400 volts and −400 volts.

The vehicles comprise under their structure a laterally displaceable collector, comprising a vertical retraction apparatus allowing electrical connection when the contact surfaces are the lower position and allowing to preserve the ground clearance of the vehicles in the upper position.

The lateral displacement of the collector consists of a pantograph arm pivoting laterally on its attachment or alternatively sliding on a transverse rail secured on the vehicle structure.

The dynamic current collector comprises at least one current collection shoe that can tilt in the cavity of the conduit with respect to a longitudinal axis located below the upper face of the conduit.

The conduit has rainwater and debris discharge openings at the base of the cavity that are larger than the width of the slit.

For static charging, the conduit is short and fixed to the pavement and does not need to be reel able. The location of the power contact surfaces can be advantageously identical to that for dynamic charging, the same collector being able to carry out static and dynamic charging. In the case of charging in a covered parking lot, the power being limited to 22 kW most likely in AC current, a known switching system will allow the recharging of the traction battery with the same collector, although it will take longer.

A lifting device allows the collector to be positioned vertically to the slit when deployed and the current shoes to be tilted laterally to contact the sloping power contact surfaces after entering the cavity through the slit.

### BRIEF DESCRIPTION OF DRAWINGS

The purpose, objects and characteristics of the invention will be more apparent after reading the description which follows referring to the drawings in which:

FIG. 1 shows an axisymmetric view with polymer removed over a short length of the pavement channel in a pavement groove according to the invention illustrating the cuts in the metal profile and on the inclined overhang of the contact surfaces.

FIG. 2 shows an axisymmetric view of the metal profile bent during transport on a coil.

FIG. 3 shows an axisymmetric view of a double lane of highway during the milling of the groove followed by the unrolling of the conduit on the pavement.

FIG. 4 illustrates an axisymmetric view of the collector engaged vertically in the pavement conduit with rain drains either lateral or vertical.

FIG. 5 shows an axisymmetric view of a static collector engaging horizontally a limited length static charging rubber bar

FIG. 6 shows an axisymmetric view of another embodiment of a static collector entering vertically the static charging bar through the upper slit according to the invention.

FIG. 7 shows an axisymmetric view of the pavement channel in a groove placed vertically on a rainwater drainage gutter.

FIG. 8 shows an axisymmetric view of another embodiment of the pavement conduit according to the invention with enlarged rainwater discharge openings.

FIG. 9 shows an axisymmetric view of a compacted wire power cable directly bearing the contact surface anchored in the cable's insulating sheath.

FIG. 10 shows a front view of a tangential wheel embedded guide “finger” in a pavement slit rail used in combination with the invention.

FIG. 11 shows an axisymmetric view of the “finger” with inclined wheels.

FIG. 12 represents a longitudinal DC static charging bar according to the invention intended for tramways with cross sections.

FIG. 13 shows an axisymmetric side view of a tramway equipped with the collector according to the invention.

FIG. 14 shows an axisymmetric rear view of the tramway's folded collector approaching the entrance to the longitudinally sectioned bar.

FIG. 15 shows a rear axisymmetric view of the lowered streetcar collector about to enter the static charging bar according to the invention.

FIG. 16 represents a front axisymmetric view of a car equipped with a folded compact collector approaching a static charging bar with increased lateral placement tolerance according to the invention.

FIG. 17 represents a front view with partial cutaway of the static charging collector with current shoes folded to engage vertically the rubber bar (not shown).

FIG. 18 illustrates the same static charging collector with current shoes deployed in a cutaway front view according to the invention, the left side of the rubber bar showing the AC configuration et the right side the DC configuration.

FIG. 19 represents an axisymmetric view of a truck equipped with a dynamic collector engaged in a continuous pavement conduit according to the invention.

FIG. 20 represents an axisymmetric view of the static collector with current shoes having a tilting axis according to the invention.

FIG. 21 represents an axisymmetric view of the dynamic collector retracted showing the current shoes having a tilting axis according to the invention.

FIG. 22 represents the rear view of the dynamic collector rolling on the pavement in the phase of approaching the slit of the conduit.

FIG. 23 represents a rear axisymmetric view of FIG. 22.

FIG. 24 represents an inclined side view of the dynamic collector illustrating the automatic emergency lifting devices in case of obstacle.

FIG. 25 shows an inclined side view of the dynamic manifold illustrating the devices for tilting and maintaining the contact pressure of the current shoes.

FIG. 26 depicts a collapsible rubber bar for static charging.

### DETAILED DESCRIPTION

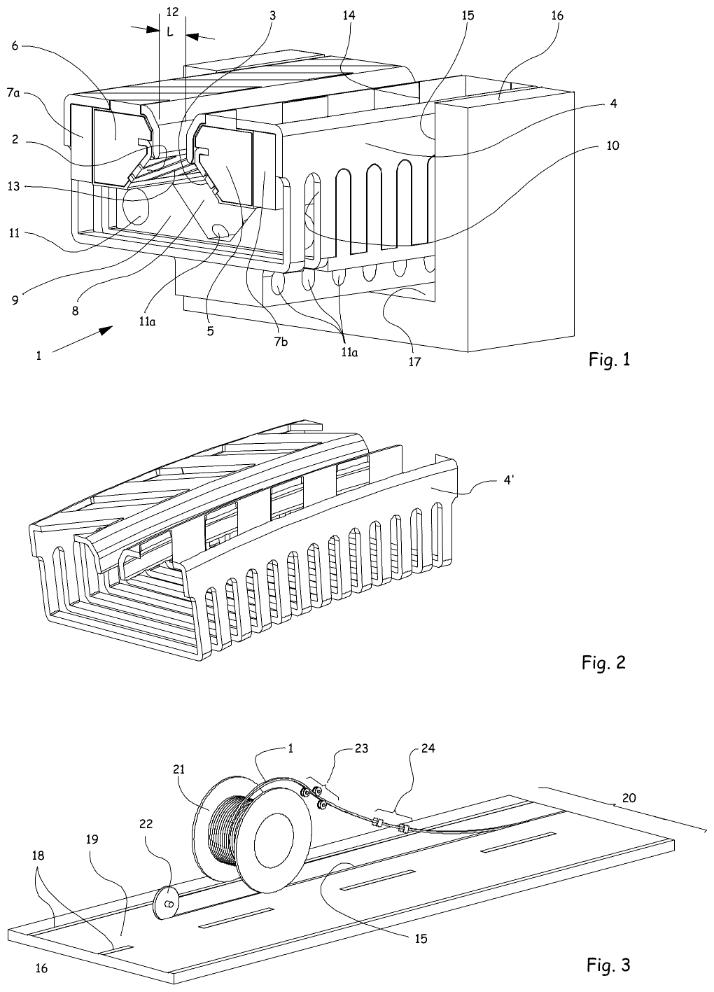

FIG. 1 illustrates the conduit 1 comprising a slit 12 of width “L” less than the safety standard preventing finger penetration into the slit 12 currently set at 12 mm in Europe (IEC 60529). The pavement conduit 1 contains:
the contact surfaces 2 and 3 in an inclined overhang which have inclined partial cuts 13, opening at the bottom to strongly reduce their resistance to bending in the plane of symmetry of the conduit,
the power cables 5 and 6, which carry the contact surfaces 2 and 3, can advantageously be connected to poles of higher and lower potential differences to “ground”,
the cables 7a and 7b are connected to the “ground”, they have substantial cross-sections because in the case of a dual-voltage supply 400 volts/800 volts the current will flow between one pole and the “ground” at 400 volts and between the two poles at 800 volts.
the metal profile 4 which advantageously has transverse cuts 10 to reduce its bending strength in the plane of the slit 12 and top cuts 14 in the parts flush with the road surface to let the polymer body 9 pass through and increase the non-slip coefficient SRT. This requirement can also be met by anti-slip paint.
the polymer body 9 contains a cavity 8 with inclined slope to allow rainwater to flow through the transverse holes 11a opening into the lateral channels 17 between the pavement and conduit, delimited by the groove 15 grinded into the pavement 16. Advantageously, the polymer body 9 may comprise longitudinal hole 11 for the purpose of transmitting various information (temperatures, etc.) or medium voltage power in particular and transversal drain holes 11a.

FIG. 2 illustrates the metal profile 4′ plastically bent when winded on the reel 21 of FIG. 3.

FIG. 3 illustrates the installation on the right-hand lane 19 of a highway or expressway 20 bordered by edge lines 18. A small groove 15 is milled into the pavement 16 by a horizontal axis rotary milling cutter 22. The conduit 1 is unwound from the reel 21 and straightened by bending rollers 23 and then, by a roller guide assembly 24 realigned with the groove 15 in which the conduit 1 is laid down and possibly fixed by gluing. A cable-winding device (not shown) will be used to span the width of the coil and an alternative solution by moving the coil laterally may be considered if the rotary milling cutter 22 and reel 21 are on the same work vehicle (not shown).

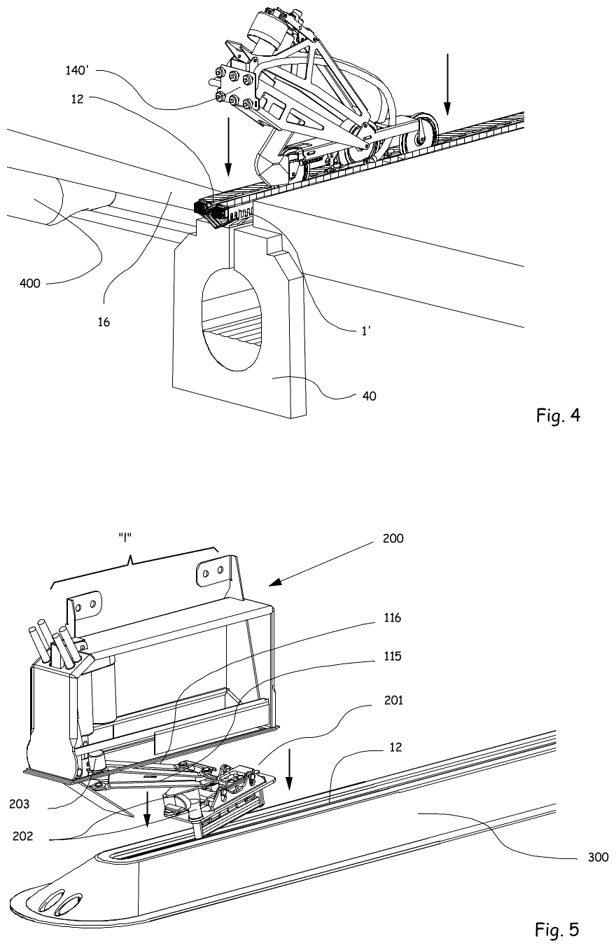

FIG. 4 illustrates a dynamic collector 140 which engages vertically the slit 12 of the continuous conduit 1′ housed in the pavement 16. The FIG. 4 shows the two configurations to drain water/debris from the conduit either laterally 400 or vertically in a drainage concrete pipe 40.

FIG. 5 illustrates a static compact collector 200 for vertical entry shown in the semi lowered position to align laterally the shoe carrier 201 with the slit 12 of the static rubber bar 300. The sensors 202 control the rotation motor 203 for swinging laterally the lateral swivel arms 115 and 116 to align the front end of the shoe carrier 201 with the slit 12, followed by further lowering of the shoe carrier 201 into the static rubber bar 300 to make-up the electrical connection.

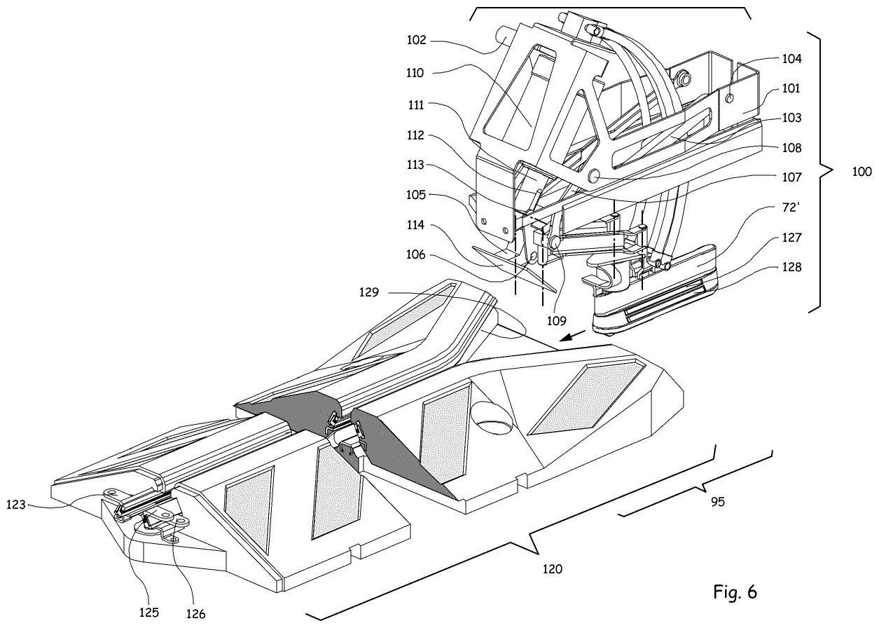

FIG. 6 illustrates another embodiment of an AC/DC compact current collector 100 described in FIG. 5 also for static charging where the compact current collector 100 shown in the deployed position is entering horizontally the rubber socket bar 120, the compact current collector 100 includes an inverted four-bar mechanism to vertically elevate the current shoe holder 72′ above the ground clearance while reducing the longitudinal footprint “1” of the collector relative to the current collector 70. The current shoe holder 72′ penetrates horizontally into the rubber socket bar 120 and is aligned by contact between the lateral surfaces of the current shoe holder 72′ and the entrance side wall 129 of the entrance 95 of the cavity 8, 8′. The compact current collector 100 has a frame 101 fixed laterally by brackets 102 to a longitudinal member (not shown) of the vehicle. The long arm 103 is attached to the frame 101 by the joint 104, with its other end attached to a knee 105 by the joint 106. The second arm of the mechanism 107 is shorter and attached to the chassis by joint 108 and to the knee 105 by joint 109. An actuator body 110 is articulated (hidden) on the frame 101 and the actuator rod 111 has a slot 112 in which a pin 113 fixed on the long arm 103 slides. This slot 112 thus allows the shoe holder 72′ to rise in the event of an impact of an obstacle with the deflector 114 of the knee 105 even if the actuator 110-111 is in the extended position.

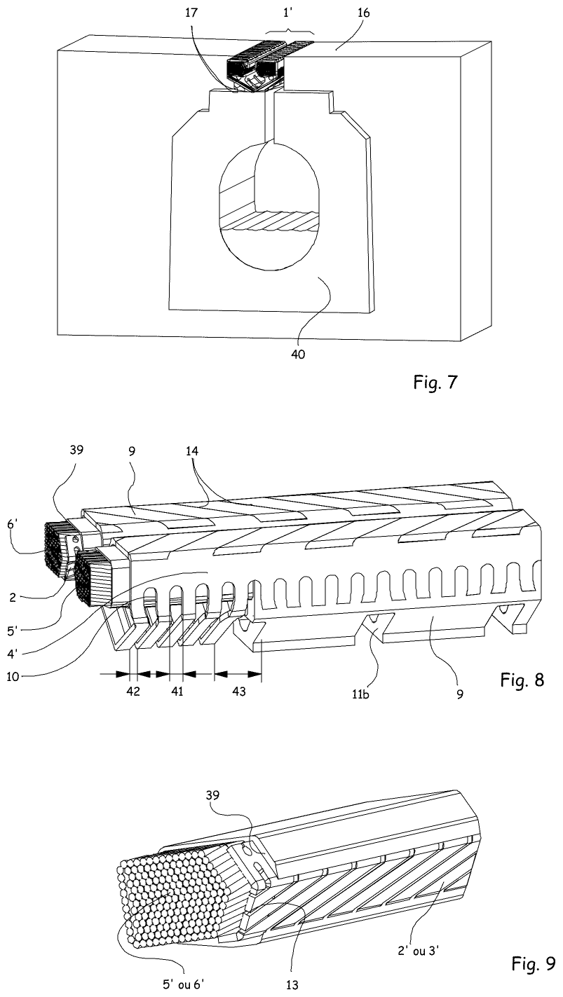

FIG. 7 illustrates a conduit 1′ slightly different from conduit 1 in FIG. 1, the upper surface of which is flush with the top of the pavement 16 in which a rainwater drainage concrete pipe 40 is located.

FIG. 8 illustrates another embodiment of the pavement conduit 1′ according to the invention comprising enlarged drain holes 11b having dimensions of drain holes 11b larger than the width of the slit 12. Advantageously, the transverse cuts 10 of the metal profile 4′ are not strictly transversally identical but have a reduced width 42 at their lower portions over a few transverse cuts compared to their regular width 41 at the upper portion so as to allow an enlarged width cut 43 for the passage of large lateral drain holes 11b.

FIG. 9 illustrates another embodiment of the power cables 5′ and 6′ with twisted compacted wires directly bearing the contact surface 2′, 3′ anchored in the insulating sheath 26. The inclined partial cuts 13 of the contact surfaces 2′ and 3′ which open at the bottom of the cable are advantageously extended at the top by an anchoring hole in the insulating sheath 39.

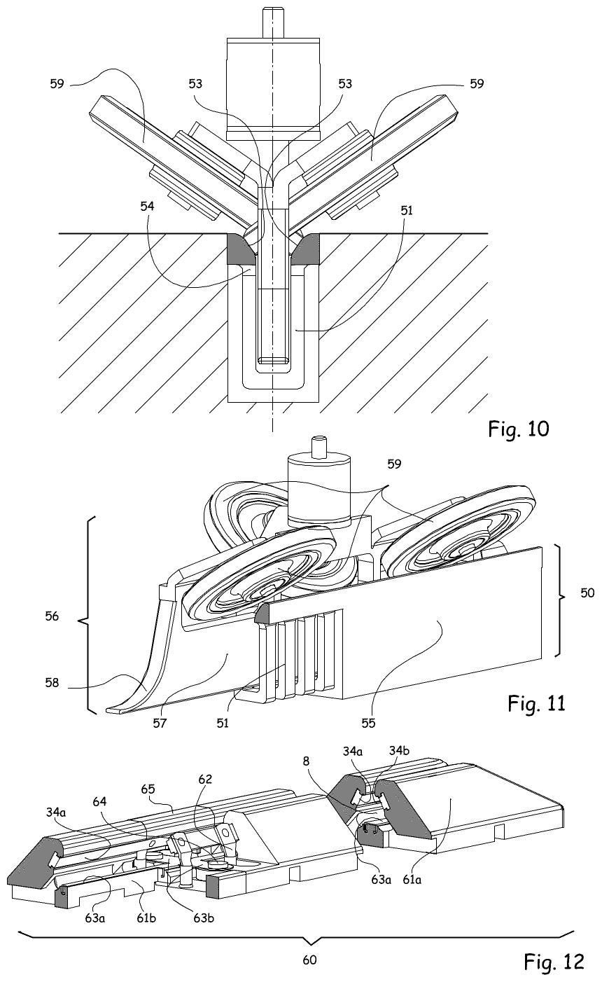

FIGS. 10 and 11 illustrate a continuously constructed pavement guide rail 50 similar to the conduit 1, 1′ but lacking contact surfaces 2, 3, while maintaining the ability to be wound onto a spool like the conduit 1, 1′ due to transverse cuts 51 at the bottom similar to transverse cuts 10. The non-open slit of width L, identical to slit 12, has two chamfers 53 on its upper part. The metal profile 54 is embedded in a polymer body 55. The vehicle (not shown) mounted guiding finger 56, which engages the guide rail 50, has the shape of a rectangular plate 57 with beak 58 at both ends to eject any debris that has fallen into the slit 51. Three inclined wheels 59 are attached to the rectangular plate 57. The inclined wheels 59 by resting on the chamfers 53 prevent the guiding finger 56 from contacting the metal profile 54 and provide a wear-free positive guiding sensing device on the guide rail that can potentially alleviate the loss of visual contact with the edge lines of a pavement in automated driving.

FIG. 12 illustrates a longitudinal DC static socket bar 60 according to the invention for use in tramways. The two bar bodies 61a and 61b are made of polymer and comprise two power supply strips 34a and 34b, with a T-shaped cross-section, which, due to their lengths which are much greater than those of the collector's current shoes 87, offer a significant tolerance in the longitudinal positioning of the shoes 87, and therefore of the vehicle carrying them, with respect to the bar 60. The connection of these power supply strips 34a and 34b from the current source is carried out in the central zone by cables connected to the bars by power supply lugs 62. At the bottom of the cavity 8, a conductive folded plate 63a runs along the bottom of the bodies 61a and 61b and comprises mounting lateral brackets 63b which serve as a support surface for the vertical bolts 64 for securing the bar 60 into the pavement, the conductive folded plate 63a being thus connected to “ground”. The power supply lugs 62 are protected by a cover 65.

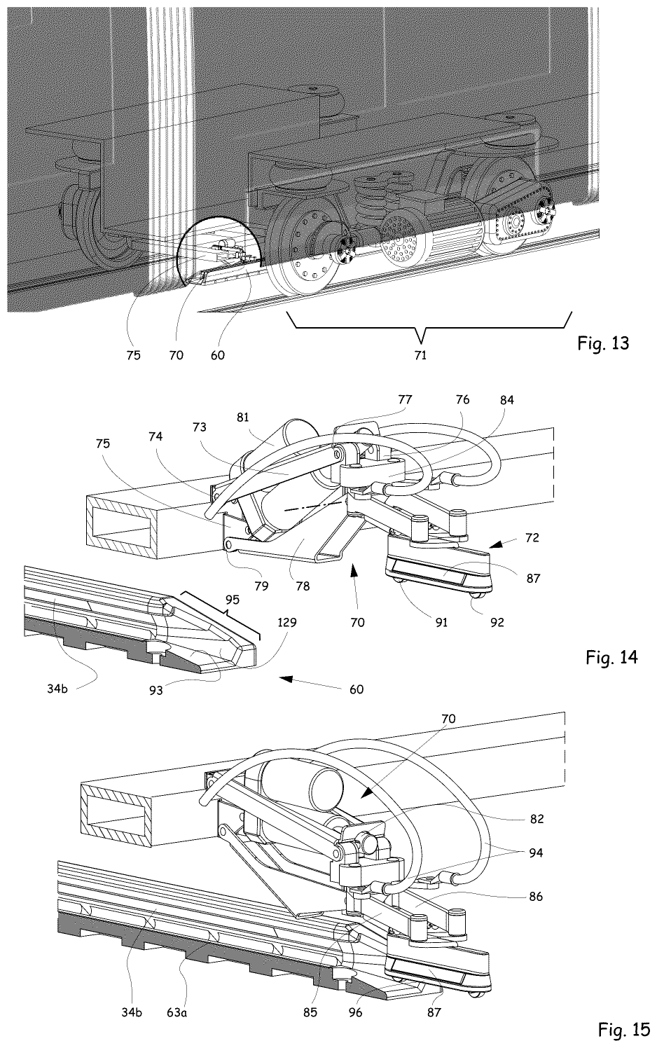

FIG. 13 illustrates a tramway equipped with the collector 70 fixed to the frame of the central bogie 71 engaged in a bar 60 to carry out rapid charges at each station, thus limiting the size of the traction batteries (not shown).

FIGS. 14 and 15 illustrate a tramway current collector 70 in a folded position while traveling between stations (FIG. 14) and lowered (FIG. 15) as it approaches the stations. The current collector 70 includes a deformable parallelogram mechanism for verti63

cally retracting the shoe's holder 72 above the ground clearance. The upper arm 73 is articulated on the axis 74 on the support 75 fixed to the bogie frame 71. At the other end of the upper arm 73 an auxiliary support 76 is articulated on the axis 77. The lower arm 78 is articulated on the axis 79 with the support 75 and on the axis 80 with the auxiliary support 76 to close the deformable parallelogram. The body 81 of the actuator is attached to the support 75. A transverse axis 83 (hidden), fixed perpendicularly on the rod of the actuator 82, slides in an integral slit (hidden) and parallel to the upper arm 73, thus allowing the shoe's holder 72 to rise in case of impact with an obstacle on the track even if the actuator is in the lowered position. The auxiliary support 76 comprises a silent bloc 84 on which are vertically articulated the conductive arms 85 and 86 which form a horizontal deformable parallelogram allowing a lateral alignment tolerance between the bar 60 and the shoe holder 72. The current shoe 87 (visible) and 88 (hidden) carry two vertical pins 89 and 90 for mechanical and electrical attachment to the bars 85 and 86. The shoe holder 72 made of insulating material has two metal wheels 91 and 92, with horizontal axes, spring-mounted to roll on the ramp 93 at the entrance of the bar 60 and then on the conductive folded plate 63a connected to the ground. The springs of the metal wheels 91 and 92 apply the proper pressure between the current shoes 87, 88 and the power supply strips 34a and 34b. Two large cross-section cables 94 electrically but flexibly connect the power supply strips 34a and 34b of the bar 60 to the terminal block (not shown) carried by the center bogie support 75 via the shoes 87, 88 and the conductor arms 85 and 86. When the shoe's holder 72 enters the bar 60, one of the side 96 contact the entrance side wall 129 of the entry funnel to align laterally the shoe's holder 72 with the bar 60 by rotation of arms (85, 86).

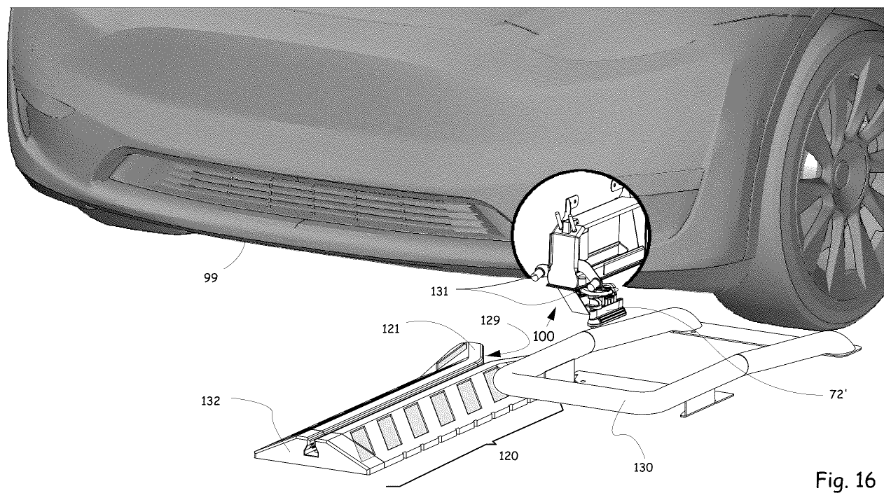

FIG. 16 illustrates a vehicle 99 equipped with a compact, static charge, current collector 100, extended after having sensed, with the sensors 131, the presence of a charging socket bar 120 with entrance 95 (hidden) and a lowered shoe carrier 72′ which will contact the entrance side wall 129 of the entrance 95 to align the shoe carrier 72′. To facilitate the connection a AVG wheel guide frame 130 can be located on the side of the charging socket bar 120. The electrical connections to the source are concealed by a cover 132.

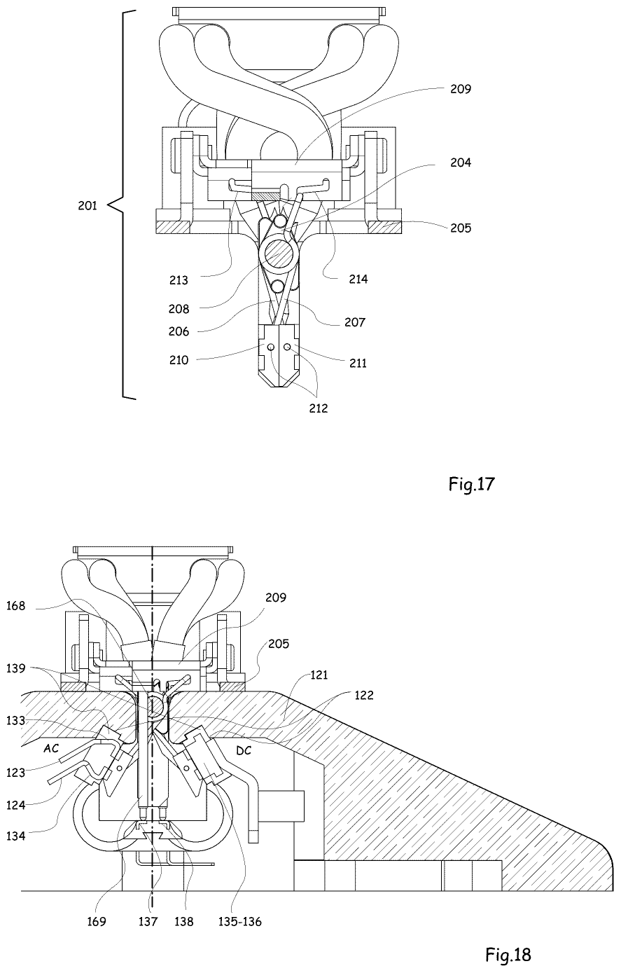

FIG. 17 illustrates, in front view and partial cutaway, the current shoe carrier 201 for vertical static charging connection, which comprises a support frame 205 containing a locking plate 209 hanging from the lateral swivel arms 115 and 116 (FIG. 5) and gravity and possibly springs (not shown) acting on the support frame 205 keeps the locking plate 209 in its upper position within the support frame 205. This upper position keeps the shoes 210, 211 folded in a vertical position back to back. The shoes 210, 211 are connected to the support frame 205 by torsion springs 206, 207 hinged on the horizontal shaft 208 of the support frame 205, the torsion springs 206, 207 being held under tension by the tensioning ring 204 on horizontal shaft 208, which has two pins to keep the torsion spring in the proper torsion to control adequate pressure on the shoes. The upper arms of the torsion springs 206, 207 follow a tilting cam profile 213, 214 on the locking plate 209, which causes the shoes 210, 211 to tilt out when the support frame 205 rests on the rubber socket bar 120 and the lateral swivel arms 115 and 116 (not shown) push down the locking plate 209, which takes up its lower position in the support frame 205.

FIG. 18 shows rubber socket bar 120, wired for single-phase/three-phase AC on the left side of the figure and wired in DC on the right side of the figure, connected to lowered shoe carrier 201. As with the bar 60, the body 121 of the rubber socket bar 120 has two T-slits 122 to receive either the single DC supply power strips 135-136 (shown on the right) or the dual AC supply power strips (shown on the left), comprising two conductors coupled in pairs 123-124, 125-126 (not shown) embedded in insulated sheath 139. These four conductors are connected to the 3 phases and neutral in AC or coupled in pairs in DC to the shoe carrier 201. Optionally, the static charging rubber socket bar 120 might comprises two “CP” contacts 137 and “PP” contacts 138, which make connection with the shoe carrier 201 via telescopic contacts 168-169, to exchange digital information, under known charging protocol, between the vehicle and the charging station.

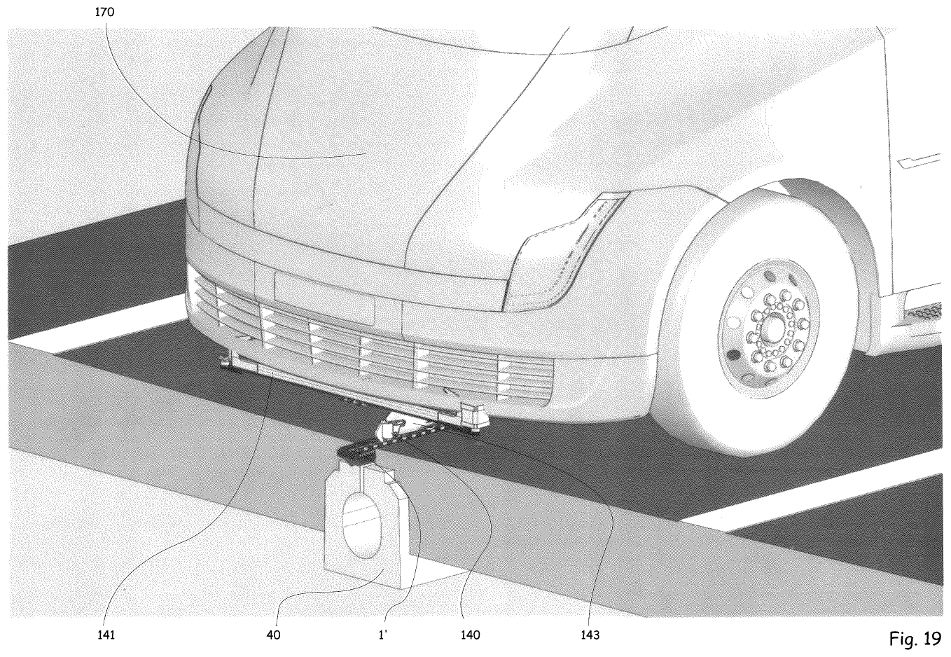

FIG. 19 illustrates a truck 170 equipped with a dynamic collector 140, according to the invention, engaged in the dynamic feed conduit 1′. The dynamic collector 140 is mounted on a transverse rail 141 advantageously disposed at the front of the truck 170. The dynamic collector 140 comprises a bumper 142 and fairings 143a, 143b on either side to reduce aerodynamic drag.

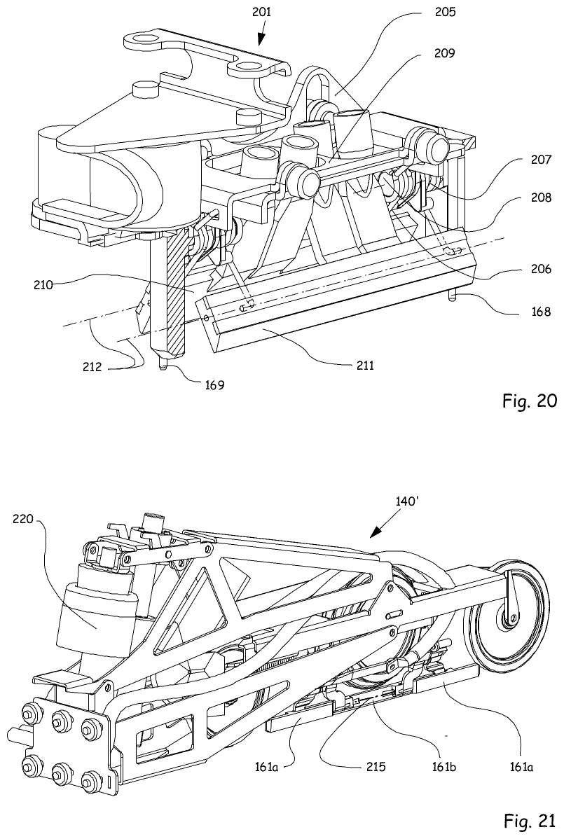

FIG. 20 illustrates, in asymmetric view, the shoe carrier 201 of the static charging compact collector 200 to show the torsion springs 206, 207 holding by theirs lower arm the shoes 210, 211 creating swinging axis 212 to advantageously provide good adequate contact pressure between the shoes and the conduit electrical feed contact surfaces in AC 123-124, 125-126 or DC 135-136.

FIG. 21 shows in asymmetric view a dynamic collector 140′ which features an emergency retractable air spring actuator 220 and longitudinal horizontal axis 215 permitting also adequate contact pressure between the DC current shoes 161a, 161b and the conduit electrical contact surfaces 2, 2′, 3, 3′ thanks to the shoe longitudinal horizontal axis 215 located at the elevation of the electrical contact surfaces 2, 2′, 3, 3′.

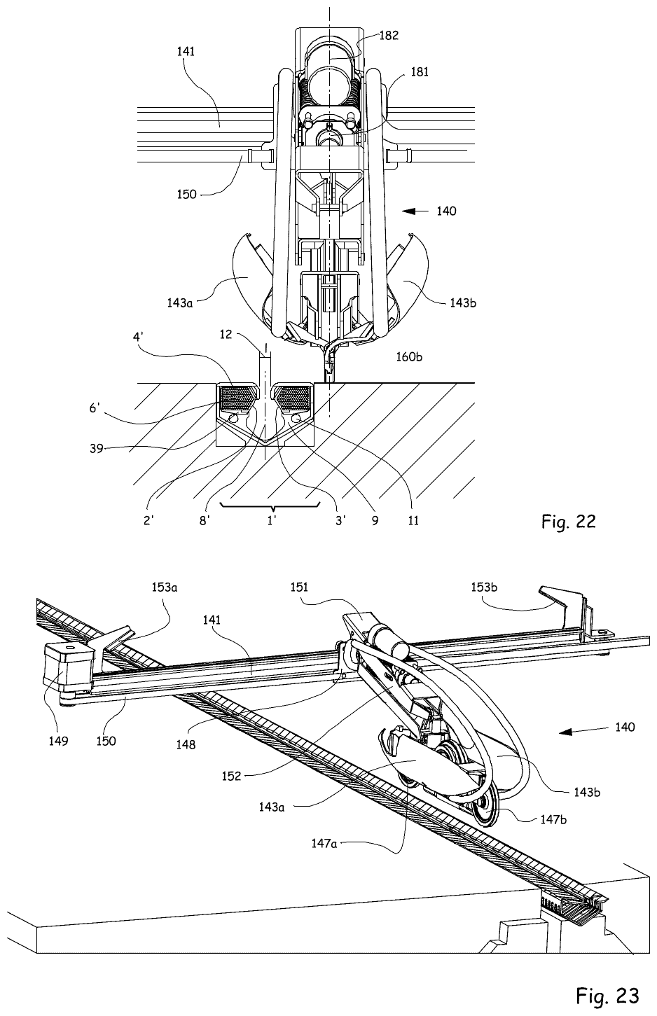

FIG. 22 illustrates the cross-sectional details of the conduit 1′ which differs somewhat from conduit 1 with single gauge cables 5, 6, 7 by having an enlarged cavity 8′, a metal profile 4b having a V-shape at the bottom, compacted wire power cables 5′ and 6′ whose insulation 26 serves as an anchor to the contact surfaces 2′, 3′.

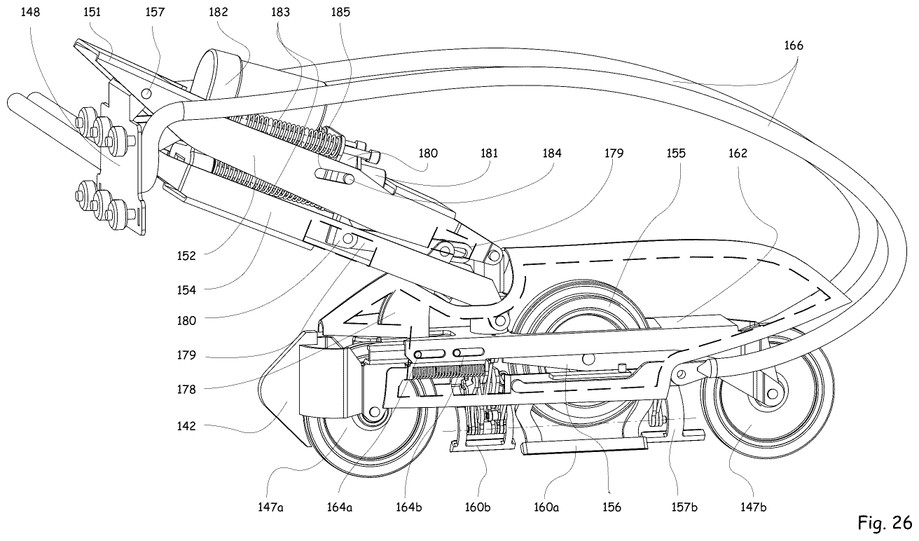

FIGS. 22 and 23 illustrate the dynamic collector 140 in the approach phase upon engagement in the slit 12 where the wheels 147a and 147b, in contact with the pavement, support the weight of the dynamic collector 140 which moves laterally on the carriage 148 sliding on the transverse rail 141. This displacement, while driving, is obtained by the action of the motor/encoder 149 acting on the belt 150 connected to the carriage 148. Similarly, if the truck changes lanes, the front part 151 of the upper arm 152 comes into contact with the inclined stops 153a and 153b fixed on the transverse rail 141, mechanically raising the dynamic collector 140.

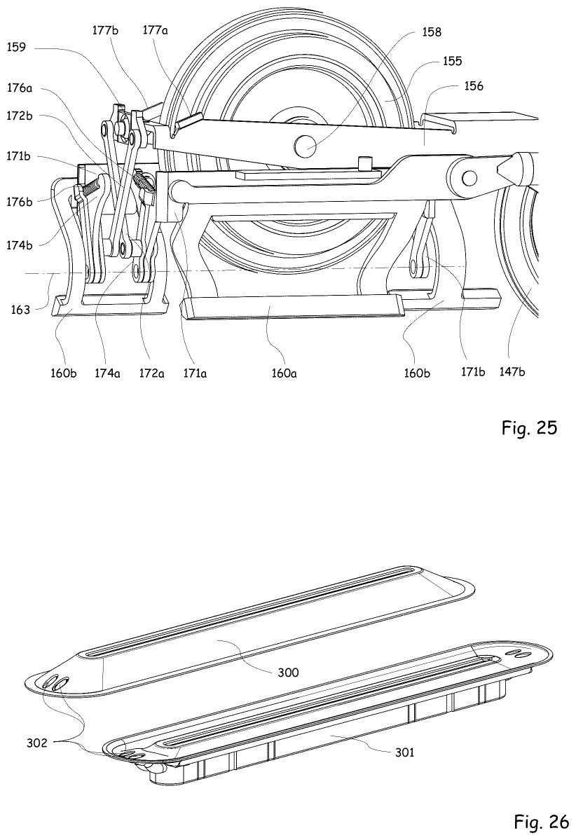

FIGS. 24 and 25 illustrate the dynamic collector 140 in detail with the vertical deformable parallelogram constituted by the upper arm 152 articulated on the carriage 148 on the axis 157, and the lower arm 154 also articulated on the carriage 148, these two arms being connected in parallelogram to the frame 162 carrying the wheel 147b. The wheel 147a is mounted on the bumper 142 which slides in the frame 162 thanks to the slots 164a and pins 164b. The bumper is held in the advanced position by the springs 165. Another wheel 155 with a possible central flange is carried by a wheel carrier 156 articulated on the axis of the wheel 147b. When the collector rolls on the wheels 147a and 147b before engaging the slit 12, gravity holds the other wheel 155 in the lowered position and via the spreader bar 159 the connecting rods 172a, 172b, the shoe holders 171a and 171b, hinged on the frame 162 on the horizontal axis 163, hold the current shoes 160a and 160b vertical in the longitudinally extruded volume of the wheels 147a and 147b as can be seen in FIG. 22. When the wheels 147a and 147b fall into the slit 12, the other wheel 155 comes into contact with the upper face of the conduit F which pushes the other wheel 155 into the upper position and by action on the connecting rods 172a 172b, the shoe holders 171a and 171b tilt the current shoes 160a and 160b on the horizontal axis 163 to bring them into contact with the contact surfaces 2′ and 3′ of the conduit 1′. In order to apply a constant pressure on the shoes, the rods 172a and 172b are not connected directly to the shoe holders 171a and 171b but to the pushers 174a and 174b articulated on the horizontal axis 163 which apply a constant pressure on the current shoe holders 171a and 171b via the springs 176a and 176b. large section wires 166 electrically connect the current shoes 160a and 160b to the carriage 148.

When an obstacle strikes the bumper 142, the springs 165 compress and the wedge-shaped rear part of the bumper 142 (not shown) rests on the inclined surfaces 177a and 177b of the wheel carrier 156 and moves the other wheel 155 to the lower position, which jointly raises the frame 162 of the dynamic collector 140 and causes the current shoes 160a and 160b to tilt to the vertical position.

At the end of the travel of the bumper 142 when the pins 164b reach the end of the travel of the slots 164a, the arm 178 of the bumper 142 pulls on the connecting rod 179 which releases the ring 180 of the actuator rod 181 by a balls/groove arrangement and the springs 183 instantly raise the collector to avoid the obstacle. In fact, the body of the actuator 182 is attached to the carriage 148 and it is the ring 180 through the pins 184 that raises the upper arm 152. Again, these pins 184 slide in slits 185 of the upper arm 152 to allow the upper arm to rise in case of impact of an obstacle with the bumper 142 even if the actuator 182-181 is in retracted position.

FIG. 26 illustrates in asymmetric view another embodiment of the static rubber bar 300 which can be collapsed 301 to advantageously avoid the static rubber bar to be an obstacle if a vehicle's wheel happen to ride on it and having end drain openings 302 for the flow of rainwater and debris of dimensions greater than the width of the slit 12 of width “L”.

It should be noted that the position of the dynamic collector 140 on the transverse rail is provided by the motor/encoder 149 and by placing the dynamic collector 140 at the front of the vehicle, the information provided by the encoder makes it possible, in highly automated driving, to control the direction of the vehicle even in the event of loss of visual reference to the border lines in rainy, dark or snowy weather, providing an additional level of safety to automated driving systems. In addition, the guiding finger 56, which can operate on the conduit 1, F or the guide rail 50, can be mounted, in a retractable manner, in parallel on the transverse rail 141 on either side of the dynamic collector 140, 140′ to allow for more advanced automation of the driving process, particularly during changes of direction, by allowing engagement for a short section of the guide rail 50 located on the right or left of the main conduit 1, F to take a left or right branch of the freeway or expressway, or to take an exit towards a logistics hub or a resting parking lot in case of driver's drowsiness. This guiding finger 56 by cooperating with the guide rail 50 can also secure the movement of driverless shuttles in urban or suburban areas, the static socket bar 60 at stops being placed parallel to and at a fixed distance from the guide rail 50.

The present invention allows for dynamic charging of electric vehicles with the aim of offering a solution to enable the reduction of the size of batteries, in particular those of heavy-duty trucks by a factor of 3 to 5 with an impact on the weight, the cost, the need to reinforce the vehicle of ICE design and the environmental impact imposed to date by the size of the latest generation of batteries on electro-mobility without dynamic charging.

It goes without saying that the devices according to the invention can be adapted to other connection configurations, and the examples just given are only particular illustrations and in no way limit the fields of application of the invention.

1. Connection device for electrical conductive, dynamic and static charging of electrically propelled vehicles comprising one or more traction batteries, one current collector (70, 100, 140, 140′, 200) on board the vehicles, and one fixed conduit (1, 1′, 60, 120, 300, 301) for power supply from the pavement (16), the conduit being substantially parallel to the direction of the displacement of the vehicles, comprising a vertical slit (12) opening into a cavity (8, 8′) of the conduit (1, 1′, 60, 120, 300, 301) to receive, the current collector (70, 100, 140, 140′, 200), the cavity (8, 8′) containing at least two electrical contact surfaces (2, 2′, 3, 3′, 123, 124, 125, 126, 135, 136) connected to a fixed current source, the contact surfaces (2, 2′, 3, 3′, 123, 124, 125, 126, 135, 136) being recessed from direct access through the slit (12) and positioned in inclined overhang (1, 1′, 60, 120, 300, 301), wherein:
the cavity (8, 8′) of the conduit (1, 1′, 60, 120, 300, 301) has dual entry capability and allows to be entered, for establishing conductive electrical connection, either:
vertically by the current collector (140, 140′, 200) through the vertical slit (12) or
horizontally by another current collector (70, 100) through at least one entrance (95) located at one end of the conduit for static charging,
the connection is established on at least three cables (5, 6, 5′, 6′, 7a, 88, 63), one of which is connected to the “ground” (7a, 7b, 63),
the vertical slit (12) of the fixed conduit (1, 1′, 60, 120, 300, 301) having a width “L” of less than 12 mm, and
the vertical entry collector (140, 140′, 200) comprises two current shoe carriers articulated on longitudinal horizontal axis (163, 208), the rotation of the current shoe holder (160a, 160b, 171a, 171b), around the longitudinal horizontal axis (163, 208), between the vertical entry/retrieval position and the lateral connected position, being less than 60 degrees.

2. Connection device according to claim 1 for dynamic supply of electrically propelled vehicles, wherein the conduit (1, 1′) is of a length exceeding the limits of road transport, the conduit comprising at least one polymer body (9) reinforced by a continuous metal profile (4, 4′) plastically deformable in the plane of the slit (12) allowing the winding of the conduit on a reel (21) of dimensions around or less than the road gauge.

3. Connection device for electrical conductive, static supply of electrically propelled vehicles according to claim 1, wherein;
the fixed conduit for supply from the pavement (16) is in the form of a rigid socket bar (60, 120, 300, 301) of length not exceeding the limits of road transport,
the current collector (70, 100) comprises a current shoe holder (72, 72′) with a width perpendicular to the plane of the slit (12) greater than 12 mm, the current shoe holder (72, 72′) penetrating horizontally into the cavity (8, 8′) via an ends's entrance (95) of the rigid socket bar (60, 120).

4. Connection device according to claim 2, wherein the continuous metal profile (4, 4′) is a profiled metal sheet open at the slit (12) and that the profile comprises partial transverse cuts (10, 10′) reducing its bending inertia in the plane of the slit (12).

5. Connection device according to claim 1, wherein the power cables (5, 5′, 6, 6′), contained in the fixed conduit (1, 1′), are made of aluminum, electrically connected to the conductive contact surfaces (2, 2′, 3, 3′) and that the contact surfaces (2, 2′, 3, 3′) have inclined partial cuts (13) reducing the bending inertia in the plane of the slit (12).

6. Connection device according to claim 1, wherein the edges of the slit (12) are of electrically conductive material connected to “ground”, the support frame (205), the other wheel (155), or inclined wheels (59) having a conductive polymer tread.

7. Connection device according to claim 1, wherein the dynamic collector (140, 140′) is carried by a vertically retractable pantograph, with arms (152, 154) articulated on a carriage (148), sliding on a transverse rail (141) secured on the structure of the vehicle (99, 170).

8. Connection device according to claim 7, wherein the dynamic collector (140, 140′) comprises at least one wheel (147a, 147b) which, in the approach phase before engagement in the slit (12), first comes into contact with the pavement (16).

9. Connection device according to claim 8, wherein the collector (140, 140′) is equipped with another wheel (155), which, in its lowered position, when the collector is rolling on the wheel (147a, 147b), keeps the current shoes (160a, 160b) vertical in the longitudinally extruded volume of the wheel (147a, 147b), the other wheel (155), when the wheel (147a, 147b) falls into the slit (12), contacts the upper face of the conduit (1, 1′) moving upward with regard to the frame (162) of the collector and causing the current shoe (160a, 160b) to tilt sideways to enter in tight contact with the contact surfaces (2, 2′, 3, 3′) of the conduit (1, 1′).

10. Connection device according to claim 7 comprising inclined stops (153a, 153b) fixed to the ends of the transverse rail (141), wherein the upper arm (152) comprises a front part (151) forward of its articulation with the carriage (148) which comes into contact with one of the inclined stops (153a, 153b) mechanically raising the collector (140, 140′) when reaching the end of the transverse rail (141).

11. Connection device according to claim 9 in which the collector comprises a frame (162), wherein the front wheel (147a) is mounted on a bumper (142), in front of the current shoes (160a, 160b), the bumper (142) sliding horizontally in the frame (162) and being maintained in an advanced position by springs (165), so that when an obstacle hits the bumper (142) the springs (165) compress and the rear part of the bumper (142) moves the other wheel (155) to the lowered position which jointly raises the frame (162) and causes the current shoes (160a and 160b) to tilt into the vertical position.

12. Connection device according to claim 11 wherein the pantograph arm (152) carrying the dynamic collector (140, 140′) is vertically retractable by the action of an actuator comprising a body (182) and a rod (181), wherein the an actuator (181, 182) comprises at least one spring (183) or an air spring actuator (220) which rests on a ring (180) sliding on the rod (181) locked in translation, the spring (183) being under load when the dynamic collector (140, 140′) is deployed, and in that at the end of the travel of the bumper (142), the spring (183) raises the dynamic collector (140, 140′) by releasing the ring (180) from the rod (181).

13. Connection device according to claim 1, wherein the conduit (1, 1′) comprises at the bottom of the cavity (8, 8′) transversal drain holes (11a, 11b) for evacuating rainwater and debris, the dimensions of drain holes (11b) being larger than the width of the slit (12).

14. Connection device according to claim 1, wherein the current collector carrying at least two current shoes (87, 88, 160a, 160b, 210, 211) which enter in a sliding contact with the inclined over hanged contact surfaces (2, 2′, 3, 3′, 123-124, 125-126, 135-136), the shoe's contact pressure being controlled by springs (183, 206, 207, 220) resting on the conduit (1, 1′, 60, 120, 300, 301).

15. Connection device according to claim 1, wherein the current shoes (210, 211, 160a′, 106b′) are articulated on a longitudinal horizontal axis (212, 215) located approximately at the elevation of the electrical contact surfaces (2, 2′, 3, 3′, 123-124, 125-126, 135-136).

16. Connection device according to claim 1, wherein the conduit (1, 1′, 60, 120, 300, 301) is made of electrically conductive material connected to the ground while the contact surfaces are covered by insulating sheath (39, 139) on all their surfaces in contact with the conduit (1, 1′, 60, 120, 300, 301).

17. Method for making-up the sliding connection device according to claim 1 where the current collector (70, 100) comprises one current shoe holder (72, 72′) free to move laterally and the fixed power supply conduit (1, 1′) is in the form of a socket bar (60, 120) wherein, the bar (60, 120) comprising, at one end, entrance side walls (129) cooperating with the retractable current shoe holder (72, 72′) in order to align the current shoe holder (72, 72′) when it penetrates horizontally into the bar (60, 120) through the bar's entrance (95) leading to the cavity (8, 8′).

18. Method according to claim 17 wherein the retractable current shoe holder (72, 72′) has spring-loaded wheels (91, 92) with horizontal axes, wherein the retractable current shoe holder (72, 72′) rolls over the ramp (93) at the entrance (95) of the bar (60, 120) and then over the conductive bent sheet (63) connected to the ground and applies the proper pressure between the current shoes (87, 88) and the power supply strips (34a, 34b).

19. Method for installation of the sliding connection device conduit (1, 1′) for dynamically powering electrically propelled vehicles according to claim 2, wherein the continuous metal profile (4, 4′) of the conduit is:
a. plastically flexed, in the plane of the slit (12) as it exits the manufacturing line to wind onto a transport reel (21) and
b. plastically straightened as it is laid down on the pavement (16).

20. Method according to claim 19, wherein the plastic straightening of the metal profile (4, 4′) during laying is done by a bending roller straightener (23).
